(19) United States
(12) Patent Application Publication
(10) Pub. No.: US 2015/0115612 A1
(43) Pub. Date: Apr. 30, 2015

(54) ROTOR FOR DYNAMO-ELECTRIC MACHINE

(71) Applicant: Voith Patent GmbH, Heidenheim (DE)

(72) Inventors: Phillipp Eilebrecht, Heidenheim (DE); Satoshi Shiraki, Heidenheim (DE); Holger Henning, Giengen (DE)

(21) Appl. No.: 14/117,495

(22) PCT Filed: Jun. 14, 2012
(86) PCT No.: PCT/EP12/02505

§ 371 Date: Dec. 18, 2013

(30) Foreign Application Priority Data
Jun. 14, 2011 (DE) 10 2011 106 481.1

(51) Int. Cl. H02K 3/50; F03B 13/08; H02K 7/18; H02K 3/48; H02K 3/51

(52) U.S. Cl. CPC H02K 3/505; H02K 3/48; H02K 3/51; H02K 7/1823; F03B 13/08
USPC 290/52; 310/214

(57) ABSTRACT

The invention relates to a rotor for a dynamo-electric machine having: a rotor body which rotates about a rotation axis which runs in the direction of gravity, winding elements which are arranged in slots which run axially in the rotor body, two winding heads which are arranged above and below the rotor body in the axial direction, wherein the winding elements emerge from the slots in the axial direction in the region of the winding heads and are connected to further winding elements, a winding head carrier for each of the winding heads, which winding head carrier is arranged radially within the winding head and coaxially to the rotation axis, and which winding head carrier is fixed at least indirectly on the rotor body, or on a component which revolves with said rotor body, in a rotationally fixed manner and such that it can move in the direction of the rotation axis. The invention is characterized by the following features: spring elements are provided in the region of the fixing means, said spring elements acting in the axial direction against the force of gravity between the rotor body, and/or a component which revolves with said rotor body, and the winding head carrier, each of the winding head carriers has at least one carrying ring which is integral or is segmented in the circumferential direction, each of the carrying rings is mounted at least indirectly in relation to the rotor body in the axial direction by means of spring elements.

The invention relates to a rotor for a dynamo-electric machine, e.g. an electric generator, according to the kind as defined in closer detail in the preamble of claim 1.

It is common practice among other things for fixing the winding heads of rotor windings to support the winding heads on the inside by an annular winding head carrier and to fix the winding heads to this winding head carrier by means of binding bands. Reference is made by way of example to U.S. Pat. No. 3,073,004 A. Especially in the case of larger machines it is also possible to use a multiply segmented ring instead of a binding band, which ring rests with intermediate insulating layers on the winding heads and is fixed by means of screws to the winding carrier. In the case of especially large centrifugal forces, caps can also be inserted over the winding heads. Such caps are especially used for fixing the winding heads of the rotor of turbogenerators (cf. the book “Leitfaden der Elektrotechnik” (Guide to Electrical Engineering), Volume 3, “Konstruktions- and Festigkeitsberechnungen elektrischer Maschinen” (Design and strength calculations of electrical machines), Dr. C. von Dobbeler (Author), 1962, B. G. Teubner Verlagsgesellschaft Stuttgart, pages 25 to 29 and 58 to 62; DE 26 29 574 B2; DE-PS 7 01 612). It is further known to absorb the centrifugal forces originating from the revolving field coil of a synchronous machine by means of holding bridges resting on the outer face side of the field coil, which holding bridges are held on their part by pins which are subjected to tension and fixed to the running body of the machine (DE-PS 9 50 659).

The object of fixing winding heads of a rotor occurs especially in rotor-fed slip-ring rotor machines, as are used in speed-controllable hydroelectric motor generators for pumped-storage operation. It is characteristic among other things for such generator motors that the rotor can have a diameter of 3 to 8 m. It is known for the purpose of fixing the winding heads of such a rotor to arrange holding rings via supporting blocks on the rotor body, in which the ends of U-shaped tension bolts are fixed. One respective tension bolt will engage with its U-shaped area behind a winding head (Report 11-104 “Development and achieved commercial operation . . . for a pumped storage power plant” of CIGRE conference 1992, August 30 to September 5). Such a winding head fixing is very complex from a constructional and installation standpoint.

DE 195 19 127 C1 describes a dynamo-electric machine of the kind mentioned above. The securing device against centrifugal forces comprises tension rods which act with their radially inner ends on a winding head carrier, e.g. from a carrier ring, and with their radially outer ends on bearing bodies which rest radially on the outside on the winding heads.

It is also known from the closest state of the art in form of DE 10 2009 016 516 A1 to support a winding head in the radial direction via tie rods, which optionally can also be arranged as tension springs.

Current flows through the winding heads. They will therefore be heated to higher temperatures and will therefore expand. No current flows through the winding head carrier on the other hand, which therefore remains cold. In order to prevent any resulting mechanical tensions, it is known from WO 2010/115483 A1 and also from GB 1,112,129 to fix the winding heads on carrier rings which are mounted in a torsion-proof manner and in the axial direction of the rotational axis of the rotor in a displaceable manner on the rotor or on a hub carrying the rotor. The winding head carrier, e.g. in form of the described carrier rings, is therefore freely movable in the axial direction at least between an upper and a bottom stop. If the winding elements now expand in the grooves of the rotor body and in the region of the winding head by heating, the winding head carrier will form a compensating movement in the axial direction.

The problem is that especially in the case of very large machines, typically in a magnitude of 30 MVA or larger, the rotational axis of the dynamo-electric machine will typically extend in the direction of gravity. As a result, the entire weight needs to be carried by the winding elements and in the event of a thermal expansion of the winding elements are displaced by the same. Since the winding head carrier is respectively heavy due to the aforementioned typical diameter of such machines, very high weight forces need to be overcome. This can lead to very high tensions in the region of the winding elements which can respectively compress and/or deform the material of the winding elements. A situation can also occur in that the winding elements, which are typically arranged in a wedged manner in the region of the grooves, are unable to completely carry the weight of the winding head carrier permanently, so that a drop of the entire winding in relation to the rotor body in the downward direction of gravity can occur over time.

It is the object of the present invention to remedy this problem and to provide a rotor which from a constructional standpoint is arranged in such a way that a thermal expansion of the winding elements in the axial direction will not lead to any unnecessarily high mechanical loading of the winding elements.

This object is achieved in accordance with the invention by the features mentioned in the characterizing part of claim 1. Advantageous further developments of the rotor in accordance with the invention and preferred uses for said developments are provided in the remaining sub-claims that are dependent thereon and the usage claims.

The configuration of the rotor with the winding heads corresponds to the configuration as also commonly used in the state of the art. One winding head carrier is provided for each of the winding heads, which winding head carrier is arranged radially within the winding head and coaxially to the rotational axis. Each of the winding head carriers is fixed at least indirectly to the rotor body in a torsion-proof manner and displaceably in the direction of the rotational axis. It is now provided in accordance with the invention that spring elements are provided in the region of this fixing, which spring elements act in the axial direction against the force of gravity between the rotor body and/or a component revolving with said rotor body and the winding head carrier. The spring elements therefore carry the part or parts of the winding head carrier in the axial direction. As a result, for the purpose of displacing the winding head carrier in the axial direction it is no longer necessary to compensate its entire force of gravity, but it is sufficient to compensate the force which arises from the difference between the spring force and the force of gravity of the winding head carrier or the affected part of the winding head carrier. The forces to be applied in thermal expansion of the winding elements on the winding head carrier are thus minimized and an excessive loading of the winding elements can reliably be prevented. The spring elements support the winding head carrier either on the rotor body itself or a component that revolves with said rotor body, e.g. the hub. It is also possible to arrange the spring elements in such a way that they rest both on the rotor body and also on the component revolving with said rotor body and support the winding head carrier.

It is provided according to an especially appropriate and advantageous further development of the rotor in accordance with the invention that the spring elements are chosen in such a way that they largely compensate the weight of the winding head carrier. This focal application of the idea in accordance with the invention with the spring elements is used for the purpose of allowing the winding head carrier to move in the axial direction in a comparatively free way, so that a movement of the winding head carrier will easily be possible in the case of the expansion of the winding elements, without having to compensate its entire force of gravity by the expanding or contracting winding elements. The spring elements thus compensate the weight of the winding head carrier at least to a large part. The term of “to a large part” shall be understood as being at least half, preferably more than two-thirds, of the weight of the winding head carrier. Ideally, compensation of the weight of the winding head carrier occurs in such a way that its entire weight can be compensated.

It can further be provided in a further, highly advantageous development that the spring elements are chosen such a way that they pretension the winding head carrier in relation to the rotor body in the direction of the force of gravity. In this development of the idea in accordance with the invention with respectively stronger spring elements, not only the weight force of the winding head carrier will be compensated completely, but the spring elements will be chosen in such a way that they additionally pretension the winding head carrier in relation to the rotor body in the direction of the force of gravity. As a result, a tensioned state of the springs can be realized during mounting, so that in regular operation, once a certain expansion of the winding elements has already occurred, they are either still respectively pretensioned or preferably are free from the force of gravity of the winding head carrier in this heated regular state during the operation of the rotor. This allows simple and efficient operation of the rotor which occurs with minimum strain over a long period of time. If a state is chosen in which slight pretensioning of the winding head carrier in relation to the force of gravity is also realized in regular operation, the dropping of the winding elements in the direction of the force of gravity will be prevented in a secure and reliable manner over a very long period of operation of the rotor.

It is obviously principally possible to choose the spring elements in approximately any kind of way. Compression springs in form of disc springs or spiral springs are possible for example, as also gas pressure springs, elastomeric springs or any combination thereof. It is obviously also possible to use different types of springs distributed over the circumference of the rotor at different support points for the winding head carrier.

Since a comparatively high thermal loading occurs in the region of the winding head, disc springs or spiral springs have especially proven their worth because they can typically be made of a metallic material and, over the typical range of the operating temperature of the rotor, ensure a respective support of the winding head carrier in a secure and reliable manner and without any major thermal influences on the spring characteristic.

Elastomeric springs can also be used or co-used very well as a supplement or alternative. They are especially advantageous, in particular concerning the flexibility of the required properties in production, since any desired spring characteristic can be achieved by using a suitable material or several suitable materials, e.g. in a layered configuration consisting of layers of different materials, and/or designs.

The rotor in accordance with the invention allows a very good, reliable and trouble-free application in a dynamo-electric machine. It is especially advantageous for respectively large machines, typically machines with more than 30 MVA nominal output. Its especially preferred application lies in the use of an induction machine with slip-ring rotor for use with variable speeds. The rotor in accordance with the invention is especially suitable for this type of design and in this case especially for a configuration of the induction machine as a double-fed induction machine because in such machines the special reliability and the simple and effective configuration of the rotor are decisively important.

The use can especially be in form of a machine unit for a hydro-electric installation, comprising a water turbine or pump turbine and a dynamo-electric machine in which a rotor of the kind mentioned above is in drive connection with the water turbine or pump turbine. The configuration of the winding head with the winding head carrier supported by the spring elements in accordance with the invention plays a decisive role especially in such a use in which rotational axes of the dynamo-electric machine which frequently extend in the direction of the force of gravity are realized. Highly fluctuating speeds and highly fluctuating temperatures frequently occur in such machines in the region of the winding head. The expansion of the winding elements in relation to the rotor body and therefore the axial displacement of the winding head carrier occur very frequently during operation. The easier the axial movement of the winding head carrier can therefore be realized, the less mechanical loading is placed on the total configuration of the rotor and the longer a malfunction-free operation of the rotor can be ensured.

In an especially preferred further development, the machine unit also provides the use of the dynamo-electric machine in form of an induction machine, especially a double-fed induction machine, with slip-ring rotor for use with variable speed.

Further advantageous embodiments of the rotor in accordance with the invention and its use are provided in the remaining dependent claims and will be explained by reference to the embodiment which is described below in closer detail by reference to the drawings, wherein:

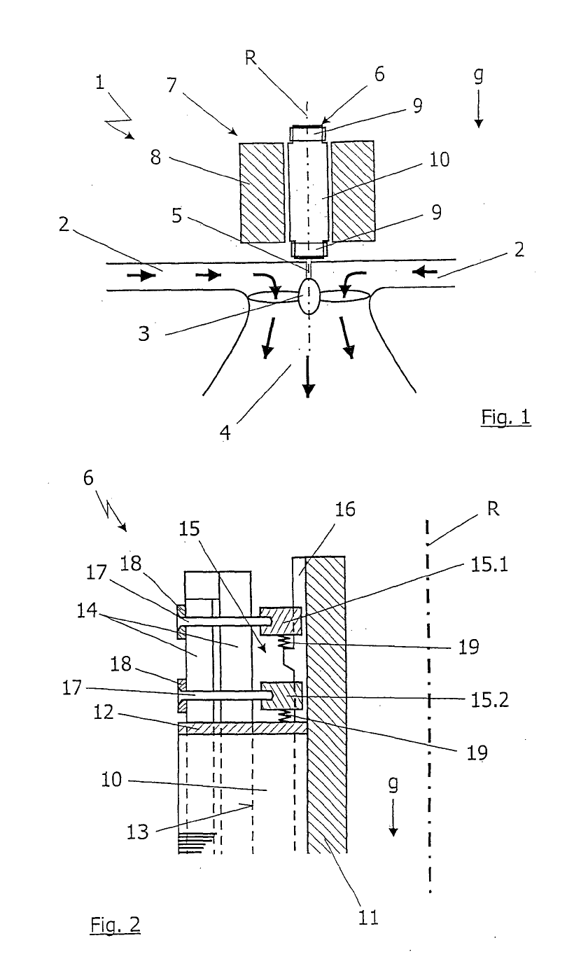

FIG. 1 shows a principle view of a machine unit for a hydro-electric installation, and

FIG. 2 shows a section of a part of a winding head of a rotor in accordance with the invention.

The illustration of FIG. 1 shows a highly schematic view of a hydro-electric installation 1. The core of the hydro-electric installation 1 is a feed system 2, which conducts water from the region of head water (not shown) to a water turbine 3 and discharges said water through a diffuser 4 (indicated in principle) into the region of tail water (also not shown). The water turbine 3 is connected via a shaft 5 to a rotor 6 of a double-fed induction machine 7 with slip-ring rotor. The rotor 6 is driven by the water turbine 3 and rotates within a principally indicated stator 8 about a rotational axis R, which (as is frequently the case in such hydro-electric installations 1) is aligned in the direction of gravity g. The rotor 6 and the stator 7 jointly form the induction machine with variable speed which is used as a generator. The induction machine 7 is used for generating electric power from the energy of the water. It would similarly be possible to use a pump turbine instead of the water turbine 3, which in a first state generates power in the induction machine 7 used as a generator in analogy to the water turbine 3, and which can pump water from the area of the tail water back to the region of the head water in a second operating state. The hydro-electric installation 1 would be a pumped storage power plant in this case, which is suitable for storing power by pumping water to a level with higher potential energy.

The rotor 6 comprises in the known manner principally indicated winding heads 9 at its two axial ends, which will now be discussed in closer detail within the scope of FIG. 2.

The sectional view of FIG. 2 shows a section of a part of the rotor 6. It rotates about the rotational axis designated with R. The rotor 6 per se substantially consists of a rotor body 10 and a hub designated with reference numeral 11. The rotor body 10 is typically arranged in a “laminated” manner. This means that the rotor body 10 is stacked by a plurality of individual sheets in the axial direction of the rotational axis R. This is symbolized in the illustration of FIG. 2 in the bottom left part of the illustrated section by a number of indicated sheets. The laminated core of the rotor body 10 can be pressed in the axial direction for example by way of a pressure plate designated with reference numeral 12 for example. The hub 11 can be arranged integrally with the rotor body 10 and can therefore also consist of individual sheets. Alternatively, it can be arranged in another configuration as a central element and carry the sheets of the rotor body 10 accordingly. Notwithstanding the specific configuration, it is always the case that the hub 11 is connected to the rotor body 10 in a torsion-proof manner. Radial movements between the hub 11 and the rotor body 10 can be possible.

In the region of the rotor body 10 there are grooves 13 which extend in the axial direction, are outwardly open in the radial direction and of which only the base of the groove is indicated here with reference numeral 13. Two respective winding elements 14, which are also known as rods 14, are inserted into these grooves 13 in a mutually insulated manner. These rods 14 leave the grooves 13 in the region of the winding head 9 and protrude in the axial direction of the rotational axis R out of the rotor body 10. The respective rods 14 are then respectively connected to further rods 14 which protrude from adjacent grooves 13 in order to thus realize the winding of the rotor 6. The winding elements 14 are fixed in the region of the winding head 9 to a winding head carrier 15. In the embodiment that is illustrated here, the winding head carrier 15 consists of two carrier rings 15.1, 15.2, which cooperate via a torsion-proof guide 16, which is arranged in the region of the hub 11, with the hub 11 and therefore with the rotor body 10. The torsion-proof guidance allows movements in the axial direction and can be arranged as a kind of gearing. The two carrier rings 15.1, 15.2 of the winding head carrier 15 are connected for example via screwed tie-rods 17 and plates or small blocks 18 which are connected to said tie rods and support the tie rods 17 in the region of the outer winding element 14. The carrier rings 15.1, 15.2 are therefore tensioned in the radial direction with the winding elements 14. This configuration shall be understood as a mere example and can obviously also be arranged in other ways. It offers the decisive advantage however that a free space is produced by the individual plates 18 in the axial direction between the plates 18 on the outer circumference of the winding head 9, which free space respectively facilitates the flow of cooling air through the winding head 9 and can therefore minimize thermal effects as a result of a strong expansion of the winding elements 14 by providing respective cooling.

The two carrier rings 15.1, 15.2 of the winding head carrier 15 are displaceable in the axial direction via the gearing 16 that is indicated here by way of example. The winding elements 14 are typically made of a well-conducting material, especially copper, and the rotor body 10 is typically made of steel sheet. This difference in the materials alone already ensures a different thermal expansion of the winding elements 14 in relation to the rotor body 10. Furthermore, current flows through the winding elements 14. As a result, they will heat up more strongly as a result of ohmic resistance than the surrounding regions of the grooves 13. In the case of a tightly clamped winding head 9, this thermal expansion would lead to massive problems because it could lead to bending of the winding elements 14 and/or a destruction of the rotor 6. The carrier rings 15.1, 15.2 of the winding head carrier 15, which are movably arranged in the axial direction of the rotational axis R, will improve this problem. However, notice must be taken that in such machines with the sizes as described above the carrier rings 15.1, 15.2 and the winding head carrier 15 can certainly have a weight in the magnitude of several tons. This weight needs to be carried and displaced by the winding elements in the case of a thermal expansion of the winding elements 14. This leads to high mechanical loading of the winding elements 14, which in the worst case can lead to a deformation of the winding elements 14 and/or buckling of the same. The configuration of the rotor 6 in accordance with the invention counteracts this effect, in that spring elements 19 are used between the two carrier rings 15.1, 15.2 of the winding head carrier 15 and parts of the hub 11 and the rotor body 10 and/or the pressure plate 12. This leads to the consequence that the weight of the winding head carrier 15 will already be taken into account by the constructional selection of these spring elements 19, which can be arranged for example as disc springs, spiral springs and/or elastomeric spring elements. The springs 19 can compensate the weight force of the winding head carrier 15, so that it can be displaced by the expanding winding elements 14 in a comparatively easy way upwardly in the axial direction, against the direction of the force of gravity g. As a result, the mechanical loading in the region of the winding elements 14 will be reduced considerably, as also the loading on a fixing of the winding elements 14 in the region of the grooves 13. This configuration can be realized in the manner as shown in FIG. 2, in the region of the winding head 9 which is situated at the top in the direction of the force of gravity g. In the region of the winding head 15 which lies at the bottom in the direction of the force of gravity g, it is obviously necessary to position spring elements 19 in such a way that they also push the winding head carrier 15 against the force of gravity g, i.e. also upwardly.

The illustrated embodiment of the winding head carrier 15 with two carrier rings 15.1, 15.2 is obviously to be understood as an example. The winding head carrier 15 can also be arranged in an integral manner or in form of even more individual carrier rings or similar elements that are arranged independently from one another or connected to each other. Every single one of the carrier rings 15.1, 15.2 can be arranged as a circumferential ring made of one or several segments. It is obviously also possible to divide the carrier ring in the circumferential direction in such a way that comparatively large gaps remain between the individual segments of the carrier ring in the circumferential direction.

1. A rotor for a dynamo-electric machine, comprising:
a rotor body rotating about a rotational axis (R) extending in the direction of gravity (g);
winding elements which are arranged in grooves extending axially in the rotor body;
two winding heads which are arranged in the axial direction beneath and above the rotor body, wherein the winding elements protrude from the grooves in the axial direction in the region of the winding heads and are connected to further winding elements;
a winding head carrier for each of the winding heads, which is arranged radially within the winding head and coaxially to the rotational axis (R), and which is fixed in a torsion-proof manner and displaceably in the direction of the rotational axis (R) at least indirectly on the rotor body or a component that revolves with said rotor body;
characterized in that
spring elements are provided in the region of the fixing, which act in the axial direction against the force of gravity (g) between the rotor body and/or a component that revolves with said rotor body and the winding head carrier;
each winding head carrier comprises at least one integral carrier ring or one that is segmented in the circumferential direction;
each of the carrier rings is mounted via spring elements in the axial direction at least indirectly in relation to the rotor body.

2. A rotor according to claim 1, characterized in that each of the winding head carriers comprises at least two, preferably precisely two, integral carrier rings, or such that are segmented in the circumferential direction.

3. A rotor according to claim 1, characterized in that the spring elements are chosen and arranged in such a way that they compensate the weight of the winding head carrier at least to a large part.

4. A rotor according to claim 1, characterized in that the spring elements are chosen and arranged in such a way that they pretension the winding head carrier in relation to the rotor body in the direction of gravity (g).

5. A rotor according to claim 1, characterized in that the spring elements are arranged as disc springs or spiral springs.

6. A rotor according to claim 1, characterized in that the spring elements are arranged as elastomeric springs.

7. The use of a rotor according to claim 1, in an induction machine with slip-ring rotor for the use with variable speed.

8. The use according to claim 7, characterized in that the induction machine is arranged as a double-fed induction machine.

9. A machine unit for a hydro-electric installation, comprising a water turbine or a pump turbine and a dynamo-electric machine, comprising a rotor according to claim 1 which is in drive connection with the water turbine or the pump turbine.

10. A machine unit according to claim 9, characterized in that the dynamo-electric machine is arranged as an induction machine, especially a double-fed induction machine, comprising slip-ring rotors for the use with variable speed.

11. A rotor according to claim 2, characterized in that the spring elements are chosen and arranged in such a way that they compensate the weight of the winding head carrier at least to a large part.

12. A rotor according to claim 2, characterized in that the spring elements are chosen and arranged in such a way that they pretension the winding head carrier in relation to the rotor body in the direction of gravity (g).

13. A rotor according to claim 2, characterized in that the spring elements are arranged as disc springs or spiral springs.

14. A rotor according to claim 2, characterized in that the spring elements are arranged as elastomeric springs.

15. The use of a rotor according to claim 2, in an induction machine with slip-ring rotor for the use with variable speed.

16. A machine unit for a hydro-electric installation, comprising a water turbine or a pump turbine and a dynamo-electric machine, comprising a rotor according to claim 2 which is in drive connection with the water turbine or the pump turbine.

17. A rotor according to claim 3, characterized in that the spring elements are arranged as disc springs or spiral springs.

18. A rotor according to claim 3, characterized in that the spring elements are arranged as elastomeric springs.

19. The use of a rotor according to claim 3, in an induction machine with slip-ring rotor for the use with variable speed.

20. A machine unit for a hydro-electric installation, comprising a water turbine or a pump turbine and a dynamo-electric machine, comprising a rotor according to claim 3 which is in drive connection with the water turbine or the pump turbine.
